(19) United States
(12) Patent Application Publication
(10) Pub. No.: US 2008/0299064 A1
(43) Pub. Date: Dec. 4, 2008

(54) COMPOSITIONS AND METHOD FOR MANAGEMENT OF HEAD LICE

(76) Inventor: Ann M. Melfi, Flint, MI (US)

Correspondence Address: GIFFORD, KRASS, SPRINKLE,ANDERSON & CITKOWSKI, P.C, PO BOX 7021, TROY, MI, 48007-7021, US

(21) Appl. No.: 12/132,688

(22) Filed: Jun. 4, 2008

Related U.S. Application Data
(60) Provisional application No. 60/941,770, filed on Jun. 4, 2007.

(51) Int. Cl. A01N 25/00

(52) U.S. Cl. 424/70.1

(57) ABSTRACT

A composition for the management of head lice includes a hair treatment base which is at least partially hair conditioner and a coloring agent in a concentration sufficient to colorize lice nits covered with the composition. The composition does not include a pediculicide selected from the group consisting of organochlorines, organophosphates, carbamates, pyrethrins, pyrethroids and neurotoxins. A method includes applying the composition to the wetted hair of a human with a lice infestation, rinsing the composition from the hair after the nits are colorized, and removing nits from the hair by visual inspection.

### CROSS REFERENCE TO RELATED APPLICATIONS

This application claims priority to U.S. provisional patent application Ser. No. 50/941,770, filed Jun. 4, 2007, the entire content of which is incorporated herein in its entirety.

### FIELD OF THE INVENTION

The present invention relates generally to compositions and methods for the management of head lice.

### BACKGROUND OF THE INVENTION

Head lice are a prevalent problem, especially among school-age children. Traditional head lice treatment products are toxic and/or ineffective. As such, there remains a need for new compositions and methods for the management of head lice.

### SUMMARY OF THE INVENTION

According to one embodiment of the invention, a composition for the management of head lice includes a hair treatment base which is at least partially hair conditioner and a coloring agent in a concentration sufficient to colorize lice nits covered with the composition. The composition does not include a pediculicide selected from the group consisting of organochlorines, organophosphates, carbamates, pyrethrins, pyrethroids and neurotoxins. According to another embodiment, a method includes applying the composition to the wetted hair of a human with a lice infestation, rinsing the composition from the hair after the nits are colorized, and removing nits from the hair by visual inspection.

### DETAILED DESCRIPTION OF THE INVENTION

The present invention provides a composition and method for the management of head lice. The composition according to the present invention includes a hair treatment base and a coloring agent. The hair treatment base may take a variety of forms, including existing head lice treatment products, hair conditioners and other materials, and preferably includes additional ingredients as will be discussed herein. The coloring agent is a material effective to colorize the head lice eggs or nits and is provided in a concentration sufficient to effectively color the nits.

The composition is applied to the scalp and hair of a person with a lice infestation and the coloring agent colorizes the nits. The composition is then rinsed out and the colored nits are removed by visual inspection.

The method for treating the head of a human according to the present invention preferably involves the following steps:
1) Wet the hair with water;
2) Apply the composition liberally to the hair and scalp;
3) Cover the hair and scalp, such as with a shower or swimming cap;
4) Leave composition on hair for a period time, such as 1 hour;
5) Rinse the composition from the hair and remove at least some of the water through drying; and
6) Remove remaining nits from hair by visual inspection.

Preferably, the above method is performed without first applying a typical lice treatment to the hair. The step of removing the nits from the hair typically involves combing through the hair using a nit comb. Preferably, the composition according to the present invention releases the attachment of the nits causing most to rinse out in the fifth step, and the remaining nits are easy to remove. Preferably, the composition also immobilizes or slows any live lice causing them to be rinsed out in the fifth step. The fourth step involves leaving the composition on the hair long enough to colorize the eggs and preferably immobilize or damage the live lice. Visual inspection may be performed during this step to determine when the live lice are immobilized.

According to a first preferred embodiment of the present invention, a composition for the management of head lice includes the following ingredients:

| Ingredient | Weight Percentage | Preferred Range |
|---|---|---|
| Hair Conditioner | 30-99% | 35-50% |
| Vinegar (5% acetic acid) | 30-60% | 35-50% |
| Cornstarch | 0-10% | 5-10% |
| Peppermint Soap | 0-5% | 1-4% |
| Peppermint Oil | 0-5% | 1-2% |
| baking soda | 0-5% | 0.5-1.5% |
| baking powder | 0-5% | 0.5-1.5% |
| dandruff shampoo | 0-5% | 0.01-0.5% |
| Coloring Agent | 0.01-5% | 0.3 to-1.5% |

As will be clear to those of skill in the art, various aspects of this list may be altered without departing from the scope or teaching of the present invention. An example of a composition that falls within this range, and forms an embodiment of the present invention, is as follows:

| Ingredient | Volume Amount | |
|---|---|---|
| Hair Conditioner | 8 | cups |
| Vinegar (5% acetic acid) | 8 | cups |
| Cornstarch | 2 | cups |
| Peppermint Soap | ½ | cup |
| Peppermint Oil | ¼ | cup |
| baking soda | ¼ | cup |
| baking powder | ¼ | cup |
| dandruff shampoo | ½ | teaspoon |
| Coloring Agent | 2 | Tablespoons |

For each of the above, the hair treatment base preferably includes a commercially available hair conditioner along with an acid-containing material such as the vinegar. It preferably also includes a thickener, such as the cornstarch, to provide a consistency sufficient to allow the composition to work into the hair without immediately running off. The desired consistency is similar to typical hair conditioning agents used following shampooing, which are subsequently rinsed out. The above ingredients will now be discussed in more detail.

Hair Conditioner

The hair conditioner is preferably a commercially available hair conditioner such as TRESemme® Hair Conditioner with Vitamin E. As used herein, the term hair conditioner refers to a rinse-out type hair conditioner suitable for use on human hair. Typical hair conditioners consist of conditioning agents such as silicone-based polymers, or equivalent, a carrier base such as water, and a thickener and or emollient. An exemplary thickener is Cocodimonium Hydroxypropyl Hydrolyzed Wheat Protein, though many alternatives will be clear to those of skill in the art. An exemplary emollient is Cetyl Alcohol, which may also serve as an emulsifier or thickening agent. Again, many alternatives will be clear to those of skill in the art. The conditioner may include any of a variety of additional ingredients, such as moisturizers, reconstructors, acidifiers, detanglers, thermal protectors, glossers, oils (including essential fatty acids), surfactants, lubricants, sequestrants, antistatic agents, fragrance, and preservatives. As will be clear to those of skill in the art, some ingredients fall into multiple categories or perform multiple functions and more or fewer ingredients may be used.

While hair conditioner is listed as forming from 30 to 99% of the weight percentage of the composition, it is preferred that hair conditioner and vinegar be provided in similar amounts and the combination of the two forms 70 to 99% of the composition. As such, in some preferred embodiments, the hair conditioner forms 35 to 50% of the total composition by weight. Less preferred is a composition consisting mostly of conditioner plus sufficient coloring agent to colorize the nits. While such a composition will colorize the nits making removal easier, it may not provide some of the benefits of embodiments including additional ingredients.

Vinegar

Preferred embodiments of a composition according to the present invention include a substantial portion of vinegar. As used herein, vinegar means a solution of 4 to 6 percent acetic acid. Those of skill in the art will recognize that other weak acids may be useful in the present invention. In preferred embodiments of the present invention, the vinegar forms 35 to 50 percent of the total by weight.

It is believed that the use of vinegar in the composition has a damaging effect on the live lice.

Cornstarch

Cornstarch is used in the above-described embodiment as a thickener. As will be clear to those of skill in the art, other thickeners may be used. It is preferred that sufficient thickener is used to provide a composition consistency similar to typical hair conditioner.

Peppermint Soap

Preferred embodiments of the composition include a small amount, such as 1 to 4% by weight, of peppermint soap. Peppermint soap as used herein is a liquid that consists of a soap base and peppermint oil. The soap base may consist of water, surfactants, and oil that serves as a moisturizer or conditioner. Typically, the oils are natural plant oils such as coconut oil, olive oil, hemp oil, and jajoba oil. It is believed that the peppermint soap serves as a surfactant and the peppermint oil has a damaging effect on the live lice.

Peppermint Oil

Preferred embodiments also contain peppermint oil in addition to the peppermint oil provided by the peppermint soap. In preferred embodiments, 1 to 2 percent by weight of the composition is pure peppermint oil. It is believed that the peppermint oil has a damaging effect on the live lice. Peppermint oil is considered an essential oil. As will be clear to those of skill in the art, other essential oils may be useful in the present invention, either instead of or in addition to the peppermint oil.

Baking Soda and Baking Powder

Some embodiments of the present invention include both baking soda and baking powder. Baking powder includes baking soda, so on alternative is to use an increased amount of baking soda and less or no balking powder. The balking soda, or sodium bicarbonate, acts as a buffer and may react with the acid in the vinegar during preparation of the composition. In some embodiments, the composition includes 0.5 to 1.5 percent by weight of baking soda and a similar amount of baking powder.

Dandruff Shampoo

Preferred embodiments of the present invention include a small amount of a dandruff shampoo, which is believed to have a loosening effect on the nits in a similar way that dandruff shampoo loosens and removes dandruff. One dandruff shampoo that works well is Sulfur8®, which includes sulfur in the formulation. It also includes menthol which serves to cool the scalp. In some embodiments, the composition includes 0.01 to 0.5 percent by weight of Sulfur8. Alternatively, this ingredient may be left out and/or sulfur and/or menthol may be added.

Coloring Agent

Preferred embodiments of a composition according to the present invention include a coloring agent or dye in sufficient concentration to effectively colorize the nits of the lice for easy visual identification and removal. The coloring agent allows for a substantial improvement in the identification of head lice eggs. Concentrations of ordinary publicly available liquid food coloring, such as MCCORMICK brand food color, have been shown to work in concentrations of approximately 0.7 percent by weight. As will be clear to those of skill in the art, other dyes, including dyes not rated as food coloring, may also be useful in the present invention. As also clear to those of skill in the art, publicly available liquid food coloring is a combination of dye and a carrier, such as water. As such, if the pure dye is used, or if a more or less concentrated solution of dye and carrier is used, the concentration of coloring agent is to be adjusted to provide the same effective level of colorization. As used herein, coloring agent refers to publicly available liquid food coloring, such as MCCORMICK brand food color, or other coloring agents at similar effective concentrations, as well as mixtures to provide other colors.

For further clarity, and as known to those of skill in the art, approved food colorings are as follows:

| FD&C name | Color Name | Chemical Name of Dye |
|---|---|---|
| FD&C Blue No. 1 | Brilliant Blue FCF, | Disodium Salt of 4-{4-(N-Ethyl-P-Sulfo benzyl- |
| | E133 | amino)-Phenyl}-(2-Sulphonium-Phenyl)- |
| | | Methylene]-{1-(N-Ethyl-N-P-Sulpho- |
| | | Benzyl)-2,5-Cyclohexadienimine} |
| FD&C Blue No. 2 | Indigotine, E132 | Disodium 3,3′-dioxo-2,2′-bi-indolylidene-5,5′- |
| | | disulphonate |
| FD&C Green No. 3 | Fast Green FCF, | ethyl-[4-[[4-[ethyl-[(3-sulfophenyl)methyl] |
| | E143 | amino]phenyl]-(4-hydroxy-2-sulfophenyl) |
| | | methylidene]-1-cyclohexa-2,5-dienylidene]- |
| | | [(3-sulfophenyl)methyl]azanium |
| FD&C Red No. 40 | Allura Red AC, | disodium 6-hydroxy-5-((2-methoxy-5-methyl-4- |
| | E129 | sulfophenyl)azo)-2-naphthalene-sulfonate |
| FD&C Red No. 3 | Erythrosine, E127 | 2-(6-hydroxy-2,4,5,7-tetraiodo-3-oxo-xanthen-9- |
| | | yl)benzoic acid |
| FD&C Yellow No. 5 | Tartrazine, E102 | 1-(4-Sulfophenyl)-4-((4-Sulfophenyl) Azo)-1h |
| | | Pyrazole-3-Carboxylic |
| FD&C Yellow No. 6 | Sunset Yellow | disodium salt of 6-hydroxy-5-[(4- |
| | FCF, E110 | sulfophenyl)azo]-2-naphthalenesulfonic acid |

The concentration of dye appropriate for use in embodiments of the present invention is a concentration sufficient to colorize the eggs or nits when the composition is left in contact with the hair for a reasonable period of time. The appropriate concentration may be determined by a simple assay by trying a composition as described herein with a starting concentration of dye, applying the composition to nits, either with or without hair, and rinsing the composition off after 30 minutes to 1 hour. If the nits remain colorized after rinsing, the concentration is at least at the minimum level. The concentration should not be so high as to dye the scalp, which may be tested in a similar manner.

A composition according to the present invention may be more generically described as including the following ingredients:

| Ingredient | Weight Percentage | Preferred Range |
|---|---|---|
| Hair Conditioner | 30-99% | 35-50% |
| Solution of Water and 5% | 30-60% | 35-50% |
| acetic acid | | |
| Thickener | 0-10% | 5-10% |
| Surfactant | 0-5% | 1-4% |
| Essential Oil | 0-5% | 1-2% |
| Sodium Bicarbonate | 0-10% | 1.5-2.5% |
| Coloring Agent | 0.01-5% | 0.3-1.5% |

In the above list, the essential oil preferably includes peppermint oil, and may also include other essential oils.

Unlike traditional compositions for the treatment of head lice infestations, preferred embodiments of the present invention do not include ordinary pediculicides, which often are toxic and may have undesirable side effects for the user. Typical pediculicides include organochlorines such as lindane and DDT, organophosphates such as malathion, carbamates such as carbaryl, pyrethrins such as pyrethrum, and pyrethroids such as permethrin, phenothrin, and bio-allethrin. The compositions according to the present invention preferably are substantially free of any of these substances and any neurotoxins. By substantially free is meant that such substances do not form an effective component of the composition, though trace amounts may be present due to other ingredients. Preferably, the compositions do not include any of these substances.

As will be clear to those of skill in the art, the herein described embodiments of the present invention may be modified in various ways without departing from the scope or teaching of the present invention. It is the following claims, including all equivalents, which defined the scope of the invention.

I claim:

1. A composition for the management of head lice, the composition comprising:
a hair treatment base including hair conditioner;
a coloring agent in a concentration sufficient to colorize lice nits covered with the composition;
wherein the composition is substantially free of a pediculicide selected from the group consisting of organochlorines, organophosphates, carbamates, pyrethrins, pyrethroids and neurotoxins.

2. A composition according to claim 1, wherein the hair treatment base further includes vinegar.

3. A composition according to claim 2, wherein the vinegar forms 30 to 60 percent of the composition by weight.

4. A composition according to claim 3, wherein the hair conditioner forms 35 to 50 percent of the composition by weight.

5. A composition according to claim 1, wherein the coloring agent is a liquid food color having a dye and a carrier, the food color forming 0.3 to 1.5 percent of the composition by weight.

6. A method for the management of head lice, comprising:
providing a composition comprising:
a hair treatment base including hair conditioner;
a coloring agent in a concentration sufficient to colorize lice nits covered with the composition;
applying the composition to the wetted hair of a human infested with lice such that substantially all of the hair is covered with the composition;
leaving the composition on the hair until the coloring agent colorizes the lice nits;
rinsing the hair to remove the composition; and
removing colorized nits from the hair by visual inspection.

7. The method according to claim 6, further comprising covering the hair with a cover during at least a portion of the leaving step.

8. The method according to claim 6, wherein the composition is substantially free of a pediculicide selected from the group consisting of organochlorines, organophosphates, carbamates, pyrethrins, pyrethroids and neurotoxins.

9. The method according to claim 6, wherein the applying step is performed prior to any treatment of the lice infestation with a lice treatment containing a pediculicide selected from the group consisting of organochlorines, organophosphates, carbamates, pyrethrins, pyrethroids and neurotoxins.

10. A composition for the management of head lice, the composition comprising:
a hair conditioner forming 30 to 99 percent by weight of the composition;
a solution of water and 5% acetic acid forming 30 to 60 percent by weight of the composition;
a thickener forming 0 to 10 percent by weight of the composition;
a surfactant forming 0 to 5 percent by weight of the composition;
an essential oil forming 0 to 5 percent by weight of the composition; and
a coloring agent forming 0.01 to 5 percent by weight of the composition;
wherein the composition is substantially free of a pediculicide selected from the group consisting of organochlorines, organophosphates, carbamates, pyrethrins, pyrethroids and neurotoxins.

11. A composition according to claim 10, further comprising:
sodium bicarbonate forming 0 to 10 percent by weight of the composition.

12. A composition according to claim 10, wherein:
the hair conditioner forms 35 to 50 percent by weight of the composition;
the solution of water and 5% acetic acid forms 35 to 50 percent by weight of the composition;
the thickener forms 0 to 10 percent by weight of the composition;
the surfactant forms 1 to 4 percent by weight of the composition;
the plant oil forms 1 to 2 percent by weight of the composition;
sodium bicarbonate forms 1.5 to 2.5 percent by weight of the composition; and
a coloring agent forming 0.5 to 1.5 percent by weight of the composition.

13. A composition according to claim 10, wherein:
the thickener forms 5 to 10 percent by weight of the composition.

14. A composition according to claim 10, wherein:
the coloring agent concentration is sufficient to colorize lice nits covered with the composition;
